(19) United States
(12) Patent Application Publication
(10) Pub. No.: US 2012/0235424 A1
(43) Pub. Date: Sep. 20, 2012

(54) Window and door auto lock

(76) Inventor: She Shun Zhang, Qinpgpu Dist Shanghai (CN)

(21) Appl. No.: 13/065,212

(22) Filed: Mar. 17, 2011

(51) Int. Cl. E05C 9/00

(52) U.S. Cl. 292/29

(57) ABSTRACT

A sliding door or window lock assembly including a sash lock housing with a pair of opposed and spaced security hooks rotatably secured to the housing, the hooks being respectively biased to a normally closed position against stops with the hooks respectively engaging window or door jamb or sill keepers thereby providing a forced entry resistance lock between a sash and a jamb or sill. A trigger lever arm is pivotally secured to the housing for hand manipulation and is positioned to simultaneously transversely engage the hooks to pivotally release them from the keepers, thereby providing a lock assembly which automatically locks upon closing of the door or window and the lock assembly is hidden and is not visible from outside of the transparent window or door panes.

### BACKGROUND OF THE INVENTION

The present invention pertains to a forced entry resistance lock assembly for sliding doors and windows.

Common horizontal and vertical sliding windows utilize a cam lock or another type of lock in combination with a keeper to connect with a frame or sash. All such prior art locks are visible from outside the window thereby revealing the type and function of the locking mechanism. In order to make such prior art locks fulfill forced entry resistance capabilities, an extra part is required to be added to the locking device in order to hide the locking mechanism and to prevent the lock from being opened from the outside of window.

### SUMMARY OF THE INVENTION

The lock assembly of the present invention provides forced entry resistance capabilities and is installed inside of the sash or frame of a sliding window or door which is invisible from outside of the frame and provides automatic locking upon closure.

The sliding door or window lock assembly of the present invention is comprised of a sash lock housing with a pair of opposed and spaced security hooks rotatably secured to this housing and respectively biased to a normally closed position against stops with the hooks respectively engaging jamb or sill keepers thereby providing a forced entry resistance lock between the sash and jamb or sill. A trigger lever arm is pivotally secured to the housing for hand manipulation and it is positioned to simultaneously transversely engage the hooks to release them from the keepers.

The hooks have sloped outer slide faces for engaging outer surfaces of the keepers upon closing of the sash against the jamb or sill, thereby causing the hooks to pivot open against their spring biases to pass and subsequently hook under the keepers for automatically locking the lock assembly upon closing of the sliding door or window.

The spaced security hooks may take on the configuration of a pair of L-shaped latches which are pivotally secured to the housing with their proximal arms aligned and their proximal ends thereof abutting against a stop, whereby the distal arms of these latches are in generally parallel alignment and extend in the same direction with their distal ends providing the spaced pair of security hooks for respectively engaging and hooking under the jamb or sill keepers. The trigger lever arm transversely engages the abutted ends of the aligned proximal ends of the proximal arms for thereby simultaneously pivoting the latches against their spring bias. This trigger lever arm may also function as the aforementioned stop to retain the L-shaped latches in their normally closed position against their spring bias.

### BRIEF DESCRIPTION OF THE DRAWINGS

Other objects and advantages appear hereinafter in the following description and claims. The accompanying drawings show, for the purpose of exemplification, without limiting the scope of the invention or appended claims, certain practical embodiments of the present invention wherein:

FIG. 1 is a perspective view of the sliding door or window lock assembly of the present invention; and

FIGS. 2, 3, 4 and 5 are schematic drawings sequentially illustrating the operation of the window lock assembly shown in FIG. 1, wherein FIG. 2 illustrates the assembly prior to closure, FIG. 3 illustrates the assembly during closure, FIG. 4 illustrates the assembly after closure and FIG. 5 illustrates the assembly being opened.

### DETAILED DESCRIPTION OF A PREFERRED EMBODIMENT

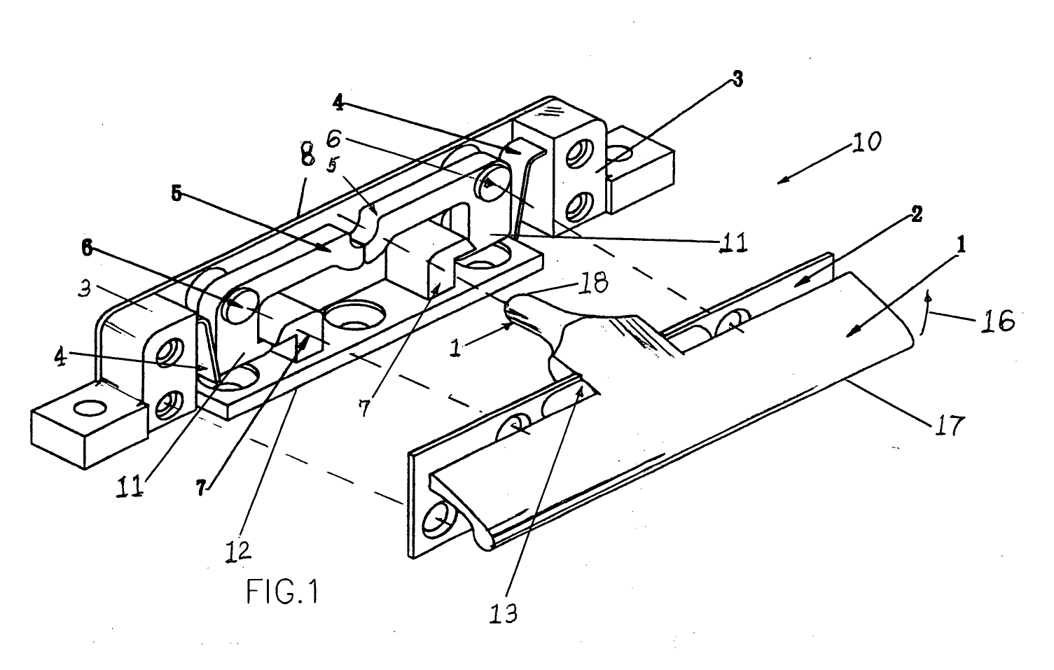

Referring to FIG. 1, an embodiment of the sliding door or window lock assembly 10 of the present invention is illustrated. The lock assembly 10 is comprised of a sash lock housing 8 which is mounted in and received in the bottom of a window sash (not shown) for a bottom window sash that slides up and down as in a common double hung window. A pair of opposed and spaced security hooks 11 are rotatably secured to the housing 8 for rotation about pivot rivet pins 6 and they are respectively spring biased by springs 4 to the normally closed position illustrated in FIG. 1 with the proximal ends 5 biased upwardly against trigger lever arm 1 as a stop, and with the hooks 11 respectively engaging jamb or sill keepers 7, thereby provided a forced entry resistance lock between a sash and a jamb or sill. In this representation of FIG. 1, the keepers 7 are secured to plate 12, which is in turn secured by screws down onto an underlying windowsill or the frame portion of a window opening (not shown).

Trigger lever arm 1 is pivotally secured to face mounting plate 2 at 13, and face mounting plate 2 is in turn secured by the screws to housing 8 via the two identical plastic side mount blocks 3 which are in turn secured to housing 8.

The two springs 4 are ribbon springs which have their proximal ends directly embedded and molded into plastic side mount blocks 3.

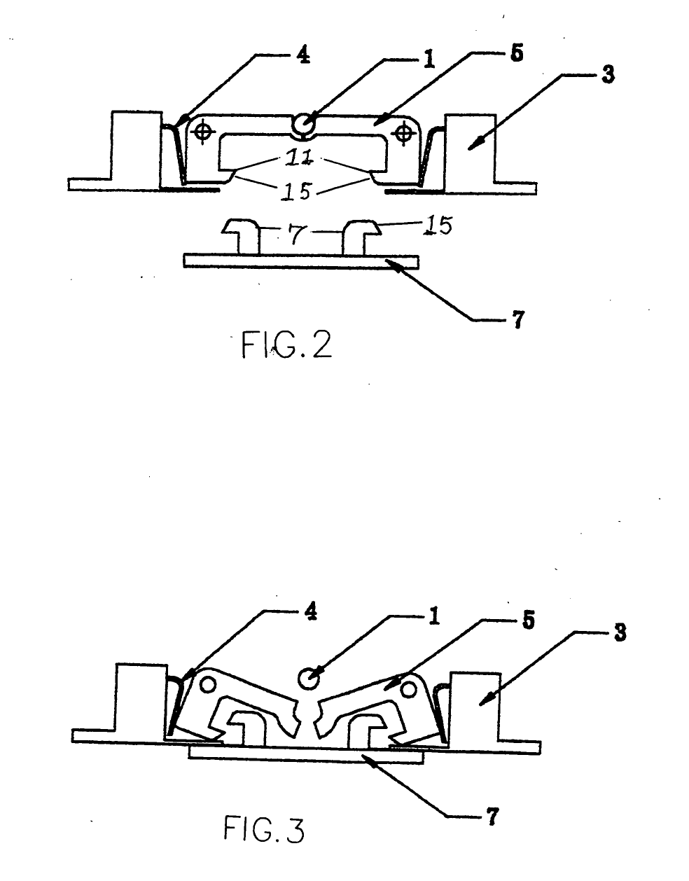

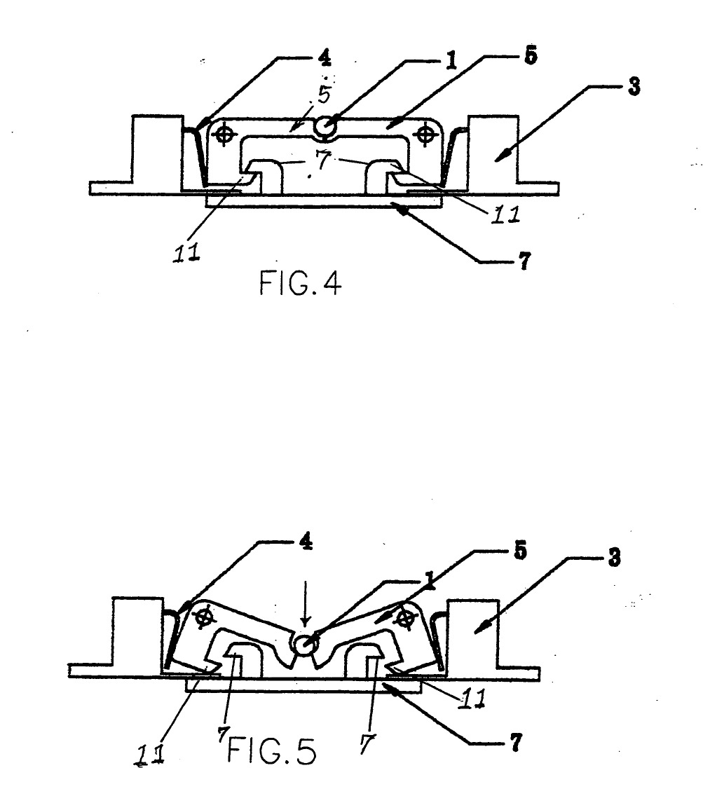

As can be best seen in the schematic sequence drawings of FIGS. 2 through 5, the hooks 11 have sloped (about 45°) outer slide faces 15 (FIG. 2) for engaging outer surfaces 16 of keepers 7 upon closing the sash against the sill, thereby pivoting hooks 11 open against their spring bias of springs 4 to pass and subsequently hook under the keepers 7 for automatically locking the lock assembly 10 as illustrated in FIG. 4. FIG. 2 illustrates the lock assembly just prior to their closing of the lock assembly, FIG. 3 illustrates the assembly at the time the hooks 11 have just passed the keepers 7 and are ready to spring inwardly by the urging of springs 4 to engage under the keepers 7 as illustrated in FIG. 4 wherein the assembly is fully closed and locked.

When one is ready to open the locked window, the operator's fingers are positioned under the leverage handle 17 of trigger lever arm 1 and the handle 17 is raised as indicated by arrow 16 in FIG. 1 to pivot the forward protruding end 18 downwardly about pivot 13 to press the proximal ends 5 of hook 11 downwardly, thereby releasing hooks 11 from underneath keepers 7 while simultaneously lifting the entire sash with handle 17 from locked engagement.

The result is that the entire lock assembly is not visible from the outside of the window and the lock assembly of the present invention automatically locks the window or door upon closure against the sill or jamb.

As an alternative, the handle 17 does not necessarily have to be part of the pivoting trigger lever arm 1 and may be instead a ledge handle secured directly to the housing 8 through mounting plate 2, and the trigger lever arm 1 may be independently provided under the handle 17 and pivoted independently to front plate 2.

I claim:

1. A sliding door or window lock assembly comprising:
a sash lock housing;
a pair of opposed and spaced security hooks rotatably secured to said housing and respectively spring biased to a normally closed position against stops with said hooks respectively engaging jamb or sill keepers thereby providing a forced entry resistance lock between a sash and a jamb or sill; and
a trigger lever arm pivotally secured to said housing for hand maipulation and positioned to simultaneously transversely engage said hooks to pivotally release them from said keepers.

2. The lock assembly of claim 1, said hooks having sloped outer slide faces for engaging outer surfaces of said keepers upon closing said sash against said jamb or sill and thereby pivoting said hooks open against said spring biases to pass and subsequently hook under said keepers for automatically locking said lock assembly.

3. A sliding door or window lock assembly for automatically locking a sash against a jamb or sill, said lock assembly comprising:
a sash lock housing mounted in said sash;
a pair of L-shaped latches pivotally secured to said housing with aligned arms of proximal ends thereof abutting against a stop and under respective spring biases thereby positioning distal arms of said latches in generally parallel alignment and extending outwardly in the same direction toward jamb or sill keepers with distal ends thereof providing a spaced pair of security hooks for respectively engaging and hooking under respective said jamb or sill keepers;
a trigger lever arm pivotally secured to said housing for hand manipulation and positioned to simultaneously transversely engage said abutted ends of said aligned proximal ends for thereby simultaneously pivoting said latches against their spring bias to release said hooks from said keepers to unlock and open said sash;
said hooks having sloped outer slide faces for engaging outer surfaces of said keepers upon closing said sash against said jamb or sill and thereby pivoting said hooks open against said spring biases to pass and subsequently hook under said keepers for automatically locking said locking assembly.

4. The lock assembly of claim 3, wherein said trigger lever arm provides said stop.
